(19) United States
(12) Patent Application Publication
(10) Pub. No.: US 2020/0319977 A1
(43) Pub. Date: Oct. 8, 2020

(54) METHOD FOR BACKING UP AND RESTORING DIGITAL DATA STORED ON A SOLID-STATE STORAGE DEVICE AND A HIGHLY SECURE SOLID-STATE STORAGE DEVICE

(71) Applicant: ISAVE INFORMATIKAI KFT., Budapest (HU)

(72) Inventor: Zsolt SAMARJAI, Budapest (HU)

(21) Appl. No.: 16/756,617

(22) PCT Filed: Sep. 7, 2018
(86) PCT No.: PCT/HU2018/050037

§ 371 Date: Apr. 16, 2020

(30) Foreign Application Priority Data
Oct. 17, 2017 (HU) U1700188

(51) Int. Cl. G06F 11/14; G06F 11/16; G06F 11/30; G06F 3/06; G06F 9/4401; G06F 21/78

(52) U.S. Cl. CPC G06F 11/1456; G06F 11/1466; G06F 11/1469; G06F 11/1464; G06F 11/1658; G06F 21/78; G06F 3/0619; G06F 3/0659; G06F 3/067; G06F 9/4401; G06F 11/3034

(57) ABSTRACT

The object of the invention relates to a method for the backing up and recovery of digital data stored on a solid-state data storage device (1), including operatively connecting the solid-state data storage device (1) to an information technology device via a connection interface (2), writing the data created during the operation of the information technology device onto the data storage device (1) via the connection interface (2) with the use of the storage controller (3) of the data storage device (1),transmitting the data previously stored on the data storage device (1) that becomes necessary during the operation of the information technology device to the information technology device via the connection interface (2) with the use of the storage controller (3) of the data storage device (1). The essence of the method is making a disc image level security backup of the digital data stored in the primary volume (4) of the data storage area of the data storage device (1) during which, by using the storage controller (3) of the data storage device (1), and copying the data through the internal data buses (7) of the data storage device (1), without any data traffic passing through the connection interface (2), from the primary volume (4) to the physically separate backup volume (5) of the data storage area of the data storage device (1), and using the storage controller (3) to copy a backed up disc image copied onto the dedicated separate backup volume (5) through the internal data buses (7) of the data storage device (1), without any data traffic passing through the connection interface (2), back to the primary volume (4) of the data storage device (1) in the case of disc image recovery. The object of the invention also relates to a high-security solid-state data storage device serving for executing such a method.

The object of the invention relates to a method for the backing up and recovery of digital data stored on a solid-state data storage device, including

operatively connecting the solid-state data storage device to an information technology device via a connection interface,

writing the data created during the operation of the information technology device onto the data storage device via a connection interface with the use of a storage controller of the data storage device,

transmitting the data previously stored on the data storage device that becomes necessary during the operation of the information technology device to the information technology device via the connection interface with the use of the storage controller of the data storage device.

The object of the invention also relates to a high-security solid-state data storage device, which contains:
a connection interface that may be connected to the data storage interface of the information technology device,
a storage controller connected to the connection interface,
a primary solid-state data storage forming a primary volume, which is in a bidirectional data communication connection with the storage controller, and which has a primary operation system installed on it which ensures the operation of the information technology device.

Primarily in the case of portable computers, data backup, in other words the creation of an offline copy of the “live” data, then the offline storage of this data for the purpose of recovering the data, requires an external data storage device, consequentially this is elaborate, difficult to automate and usually very slow.

In recent times solid-state data storage devices not containing any moving parts are replacing traditional hard disc drives at an increasingly faster rate, especially in portable computers. The advantages of these, such as speed and energy efficiency, are well known, and according to general experience their reliability is also good. However, if they become faulty there is no known solution for recovering the stored data as opposed to traditional hard drives, this is why performing a data backup onto an external device at the appropriate frequency is almost the only option in the case of computers fitted with SSDs (Solid-State Drive). External device is understood to mean hard discs, thumb drives, etc. that can be connected to and disconnected from a computer via, for example, a USB port, but these also include various network and cloud backups.

Patent specification number US 2013/159603 A1 proposes a solution with which the data of a semiconductor storage device are periodically manually or automatically copied onto a backup copy device in the interest of avoiding data loss. Although this solution makes it possible to make a backup copy of the data from an operating data storage device onto an independent device, it is necessary to use the own hardware and software of the information technology device, such as a portable computer, to both make and recover the copy.

Another known solution is when the data storage device built into the computer is divided into several logical parts, partitioning, where the one partition is the primary, operation volume, and another partition is the backup volume, which serves for storing the backups, and the backups are copied to the backup area by the computer's hardware and operation system. This is definitely faster that the use of an external device as indicated previously, however, this arrangement does not offer a solution to the aforementioned problem either, in other words not even the backups will be accessible any more in the case the data storage device becomes faulty.

The objective of the invention was to create a solution that makes it possible to regularly store the data of a solid-state data storage device built into a computer as a backup copy even independently of user intervention, either as a disc image, or with file-level storage, in such a way that the data area used for the backup copy is physically constructed together with the operation data store, but is still separate, and so that there is no need to use the computer's own hardware or software devices for the storage and recovery of the data.

The invention is based on the recognition that the parameters of the electronic components used in the solid-state data storage devices make it possible to build in one or more physically separate components into a single conventional or standard sized solid-state data storage device, and to connect the data storage device and the device containing the backup copy directly to each other via electronics ensuring a communication connection in addition to the computer's own, customary electronics.

The set task was solved, on the one part, with the method according to claim 1.

The set task was solved, on the other part, with the high-security solid-state data storage device according to claim 4.

In the context of the invention a solid-state data storage device is understood to mean a data storage device that does not contain moving parts and maintains the stored data even when its power supply is switched off. Solid-state data storage is understood to mean a data storage element within the solid-state data storage device that does not contain moving parts and maintains the stored data even when its power supply is switched off. Examples of such include an eMMC flash memory or a micro SD card.

The more important preferred embodiments of the invention are listed in the sub-claims. An embodiment of the device according to the invention is preferable in which the data storage capacity of the further data storage area is 1.5 to 2 times the data storage capacity of the primary data storage area of the data storage device. This ensures that there is space for file-level backups on the data storage area in addition to the disc image.

According to a preferred embodiment the storage modules are implemented as micro SD cards, which are arranged on the housing of the device, in slots. The latter ensure a stable mechanical and good electrical connection for the cards, and also facilitate their replacement.

In the case of a further preferred embodiment of the proposed solid-state data storage device the control unit connected to the storage modules is a control unit that ensures at least one of the standard RAID levels with respect to the storage modules.

According to a further preferred embodiment the further data storage area and the control unit are arranged inside the standard sized housing of the data storage device.

The method according to the invention, as well as the structure and operation of the device are presented in detail on the basis of exemplary embodiments with reference to figures, wherein:

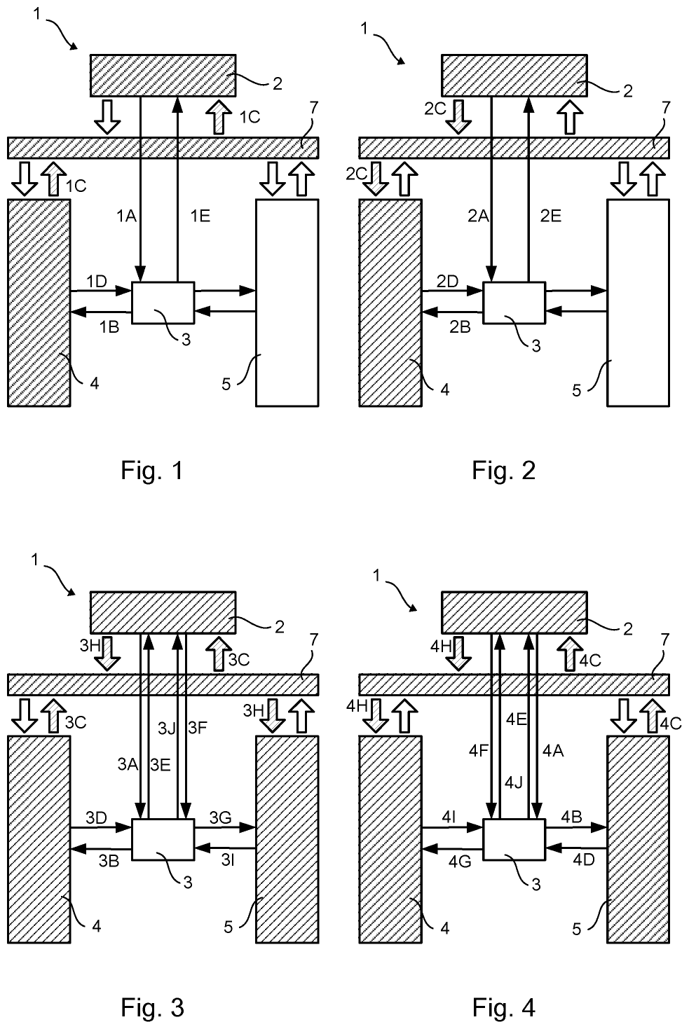

FIG. 1 depicts a flow chart of a possible method of implementation of the method according to the invention in the course of data reading,

FIG. 2 depicts a flow chart of a possible method of implementation of the method according to the invention in the course of data writing,

FIG. 3 depicts a flow chart of a possible method of implementation of the method according to the invention in the case of performing a file-level backup,

FIG. 4 depicts a flow chart of a possible method of implementation of the method according to the invention in the case of performing file-level recovery,

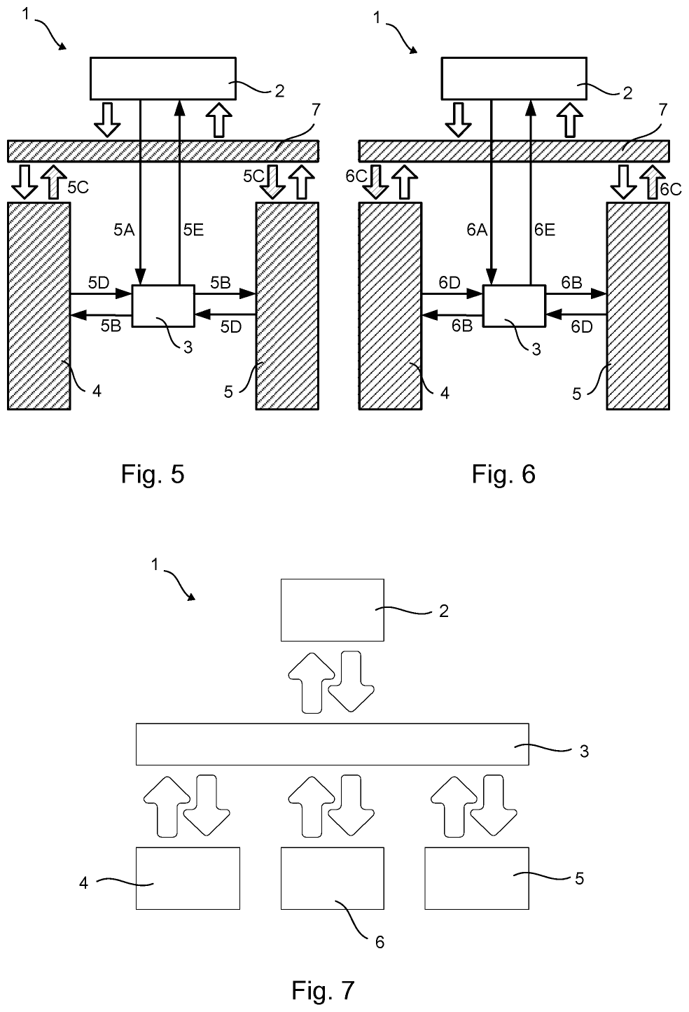

FIG. 5 depicts a flow chart of a possible method of implementation of the method according to the invention in the case of performing a disc image backup,

FIG. 6 depicts a flow chart of a possible method of implementation of the method according to the invention in the case of performing a disc image recovery,

FIG. 7 shows a block diagram of a possible embodiment of the device according to the invention,

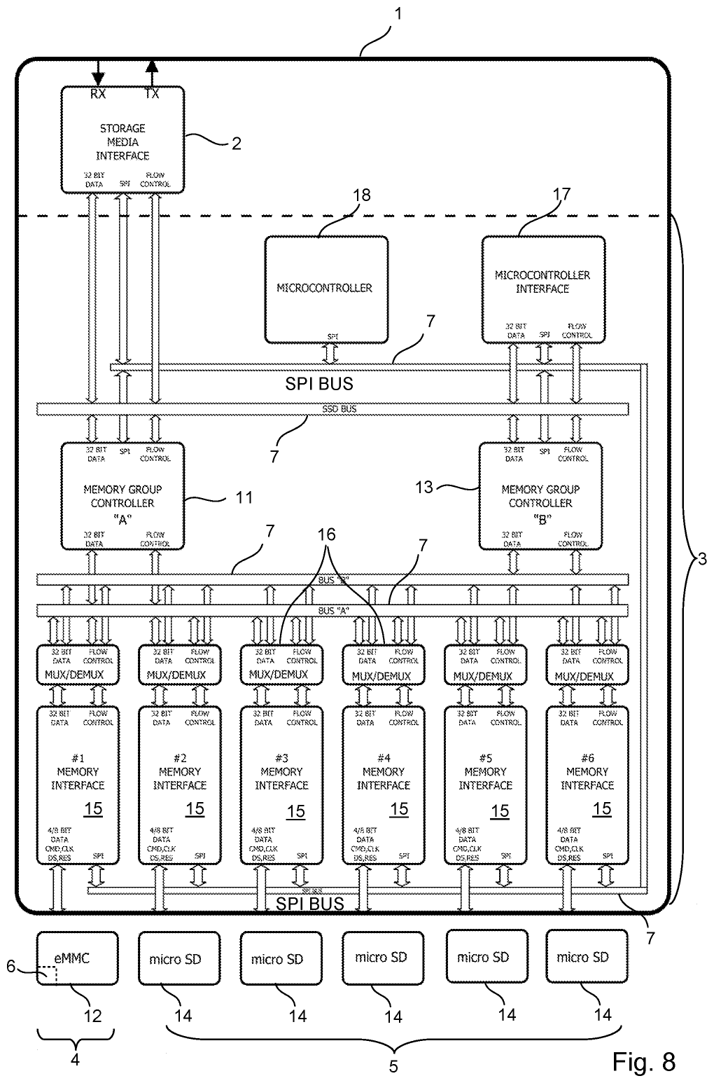

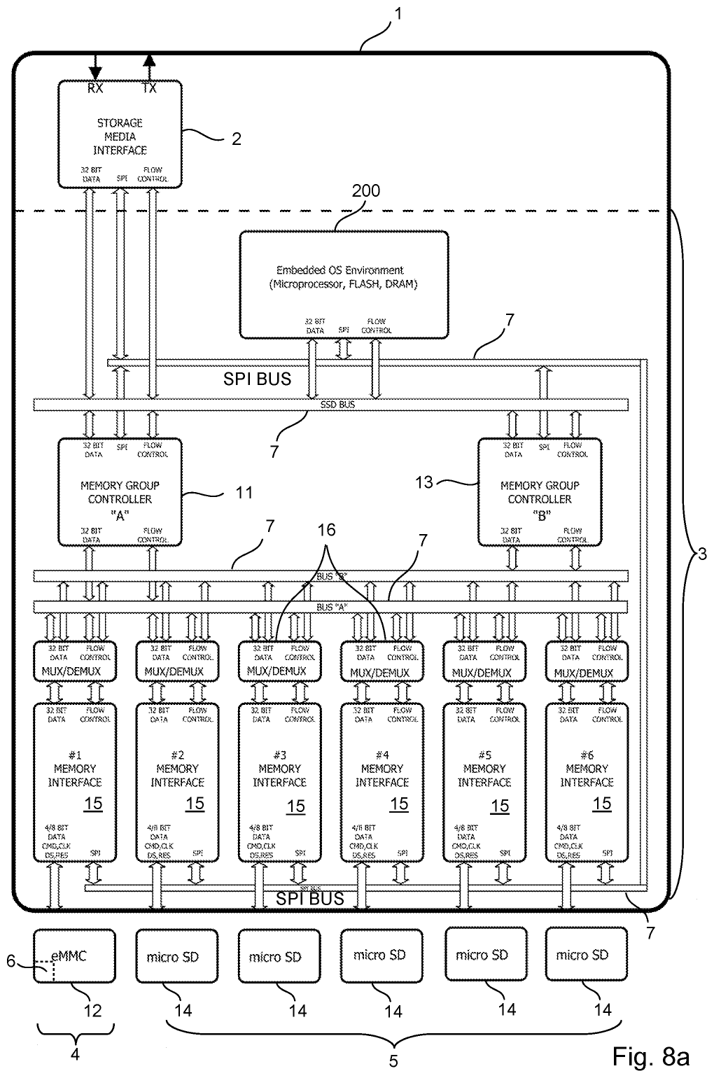

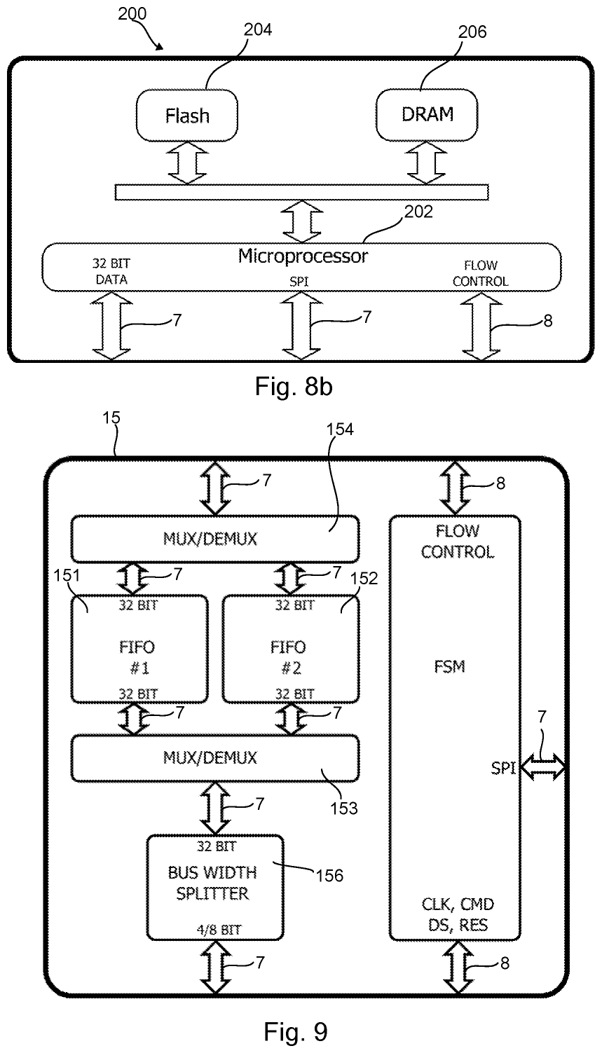

FIG. 8 shows a detailed block diagram of a possible embodiment of the device according to the invention, and the flow of data in the device has also been depicted in the course of normal operation, i.e. during writing and reading,

FIG. 9 depicts a possible form of implementation of the memory interface level of the device according to FIG. 8,

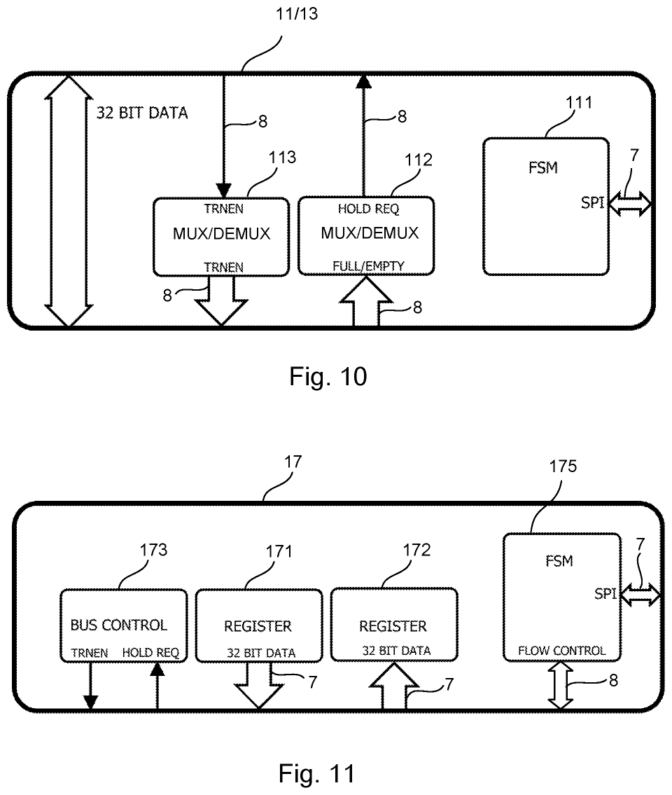

FIG. 10 shows a possible form of implementation of the memory group control level of the device according to FIG. 8,

FIG. 11 shows a possible embodiment of the microcontroller interface level of the device according to FIG. 8,

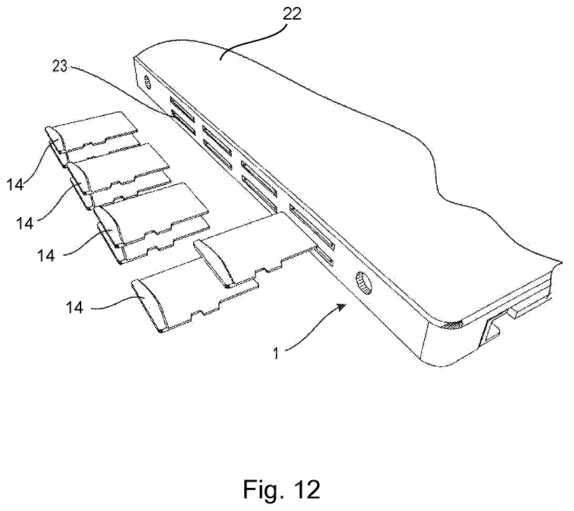

FIG. 12 depicts the data flow taking place in the device according to FIG. 8 in the case of file level backup and recovery,

FIG. 13 depicts the data flow taking place in the device according to FIG. 8 in the case of disc image backup and recovery,

FIG. 14 depicts a preferred embodiment of the device according to the invention.

FIG. 7 shows a block diagram of a possible embodiment of the high-security solid-state data storage device 1 according to the invention. The figure illustrates the logical connection between the individual units, the actual physical implementation largely depends on the selected technology. The device 1 preferably has a standard arrangement widely used in practice, this today means a size of 3½, 2½, or an even smaller size of 1,8″, 1″, the advantage of which is the device may be easily installed in the space in computers provided for the storage device, and its replacement is also extremely simple.

The high-security solid-state data storage device 1 according to the invention contains a connection interface 2 that may be connected to the data storage interface of an information technology device. In the following the expressions “information technology device”, “information technology equipment”, “host computer”, “host”, “host machine”, etc. are used as synonymous expressions, and these are understood to mean the information technology equipment to which the solid-state data storage device 1 is (may be) connected. The connection interface 2 is an interface that corresponds to the appropriate interface of the computer (or other information technology device), which may be, for example SATA, SAS, PCI-E, NVMe, or USB.

The data storage device 1 also contains a storage controller 3 connected to the connection interface 2 and a primary solid-state data storage forming a primary volume 4, which is in a bidirectional data communication connection with the storage controller 3, and which has a primary operation system installed on it which ensures the operation of the information technology device. Furthermore, the data storage device 1 according to the invention also contains a further solid-state data store, which forms a secondary volume, otherwise known as a backup volume 5. The backup volume 5 may be accessed by the user by it being composed of one or more removable and replaceable data storage modules (in other words, the solid-state data storage contains one or more data storage modules). The one or more data storage modules are also in a bidirectional data communication connection with the storage controller 3.

The storage controller 3 is provided as a control unit containing program code commands that cause the solid-state data storage device 1 to execute the method according to the invention, as will be explained in detail at a later stage. FIG. 7 schematically shows a service volume 6 that is logically separated from the primary volume 4 and the backup volume 5, the storage space of which contains an auxiliary operation system (such as the Linux operation system) required for restoring the disc image saves. Physically the service volume 6 may be on any solid-state data store, preferably, for example, on a part of the backup volume 5, in this way the host computer connected to the solid-state data storage device 1 via its interface 2 may be started using the auxiliary operation system installed on the service volume 6 in the case the primary volume 4 becomes faulty. This service volume 6 may be useful if the content on the primary volume 4 becomes logically corrupted, in this case the host computer may be started from the service volume 6, then the data may be restored from the backup volume 5 onto the primary volume 4. If a hardware-level fault occurs to the primary volume 4, the backup volume 5 is preferably comprised of elements that are accessible and removable by the user (such as of micro SD cards), therefore these may be transferred to another data storage device 1 containing an intact primary volume 4, which after being connected to the host computer the entire data content may be restored from the backup volume 5 onto the intact primary volume 4.

FIGS. 1 to 6 illustrate examples of some preferred embodiments of the use of the solid-state data storage device 1 according to the invention. For the purpose of simplicity the service volume 6 is not indicated in these figures, however, a data bus 7 has been schematically shown, which enables data transfer between the primary volume 4, the backup volume 5, and an external information technology device via the connection interface 2. During use the connection interface 2 of the solid-state data storage device 1 is connected to the connector of the information technology device provided for storage devices, in other words to the data storage interface. During the “normal”, as designated in the present specification, regular operation of information technology device, which is characteristically but not exclusively a computer, data are read and written via the connection interface 2 of the solid-state storage device 1.

The following is performed in the case of an exemplary case of the execution of data reading (FIG. 1):
1A—Receiving a read request through the interface 2 connected to the computer, otherwise referred to as a host, with the help of the storage controller 3 of the solid-state data storage device 1.
1B—Sending a read command from the storage controller 3 of the solid-state data storage device 1 to the primary volume 4.
1C—Following this transferring the requested data content from the primary volume 4 through the data bus 7 and the interface 2 to the host. The units indicated with arrows in FIG. 1 participate in the data transfer. Data transfer/data movement is also indicated with arrows in the other figures.
1D—Sending confirmation of the completion of the data movement with the primary volume 4 to the storage controller 3.
1E—The latter sending a “read complete” signal to the host via the connection interface 2.

The following is performed in the case of an exemplary case of the execution of data writing (FIG. 2):
2A—Receiving a write request through the connected interface 2 with the help of the storage controller 3 of the solid-state data storage device 1.
2B—Issuing a write command using the storage controller 3 to the primary volume 4.
2C—Transferring the data content to be written from the host through the interface 2 and the data bus 7 to the primary volume 4. The units indicated with arrows in FIG. 2 participate in the data transfer.
2D—Sending confirmation of the completion of the data movement using the primary volume 4 to the storage controller 3.
2E—The latter sending a “write complete” signal to the host via the connection interface 2.

The following is performed in the case of an exemplary case of file-level backup (FIG. 3):
3A—Receiving a read request from the host through the connected interface 2 using the storage controller 3 of the solid-state data storage device 1.
3B—Issuing a command using the storage controller 3 to the primary volume 4.
3C—Transferring the requested data content from the primary volume 4, through the internal data bus 7 then the connected interface 2 to the host. The units indicated with arrows in FIG. 3 participate in the data transfer.
3D—Sending confirmation of the completion of the data movement using the primary volume 4 to the storage controller 3.
3E—The storage controller 3 sending a “read complete” signal to the host through the connection interface 2. p1 3F—Receiving a “file security backup write” request from the host through the connection interface 2 using the storage controller 3 of the solid-state data storage device 1.
3G—Issuing a write command using the storage controller 3 to the backup volume 5.
3H—Transferring the requested data content from the host to the backup volume 5 through the connection interface 2 then the internal data bus. The units indicated with arrows in FIG. 3 participate in the data transfer.
3I—Sending confirmation of the completion of the data movement to the storage controller 3 using the backup volume 5.
3J—The storage controller 3 sending a “backup complete” signal to the host through the connection interface 2.

The following is performed in the case of an exemplary case of file-level recovery (FIG. 4):
4A—Receiving a recovery request from the host through the connected interface 2 with the help of the storage controller 3 of the solid-state data storage device 1.
4B—Issuing a read command using the storage controller 3 to the backup volume 5.
4C—Transferring the requested data content from the backup volume 5 to the host through the internal data bus and the connected interface 2. The units indicated with arrows in FIG. 4 participate in the data transfer.
4D—Sending confirmation of the completion of the data movement using the backup volume 5 to the storage controller 3.
4E—The storage controller 3 sending a “read complete” signal to the host via the connection interface 2.
4F—Receiving a “file write” request from the host through the connection interface 2 using the storage controller 3 of the solid-state data storage device 1.
4G—Issuing a write command using the storage controller 3 to the primary volume 4.
4H—Transferring the requested data content from the host to the primary volume 4 through the connection interface 2 then the internal data bus. The units indicated with arrows in FIG. 4 participate in the data transfer.
4I—Sending confirmation of the completion of the data movement to the storage controller 3 using the primary volume 4.
4J—The storage controller 3 sending a “data recovery complete” signal to the host through the connection interface 2.

The following is performed in the case of an exemplary case of disc image backup (FIG. 5):
5A—Receiving a disc image backup request from the host through the connected interface 2 with the help of the storage controller 3 of the solid-state data storage device 1.
5B—Issuing a read command to the primary volume 4 and a write command to the backup volume 5 using the storage controller 3.
5C—Transferring the requested data content from the primary volume 4 to the backup volume 5 through the internal data bus. The units indicated with arrows in FIG. 5 participate in the data transfer.
5D—Sending confirmation of the completion of both the reading and the writing processes using both the primary volume 4 and the backup volume 5 to the storage controller 3.
5E—The storage controller 3 sending a “disc image backup complete” signal to the host via the connection interface 2.

The following is performed in the case of an exemplary case of disc image recovery (FIG. 6):
6A—Receiving a recovery request from the host through the connected interface 2 with the help of the storage controller 3 of the solid-state data storage device 1.
6B—Issuing a write command to the primary volume 4 and a read command to the backup volume 5 using the storage controller 3
6C—Transferring the requested data content from the backup volume 5 to the primary volume 4 through the internal data bus. The units indicated with arrows in FIG. 6 participate in the data transfer.
6D—Sending confirmation of the completion of both the writing and the reading processes using both the primary volume 4 and the backup volume 5 to the storage controller 3.
6E—The storage controller 3 sending a “disc image recovery complete” signal to the host via the connection interface 2.

In other words during the disc image level security backup the digital data stored in the primary volume 4 of the data storage area of the data storage device 1 are copied using the storage controller 3 of the data storage device 1 only through the internal data buses 7 of the data storage device 1 (in other words without using the data buses of the information technology device), and so without any data traffic passing through the connection interface 2, from the primary volume 4 to the physically separate backup volume 5. Copying without any data traffic occurring through the connection interface 2 is understood to mean that the data to be copied is not transmitted to the information technology device through the connection interface 2, but, naturally, data movement of a different nature cannot be excluded, for example it may happen that the storage controller 3 of the data storage device 1 sends confirmation of the launching of the copying process, or other commands may arrive during the copying via the connection interface 2. In other words the essence of copying without any data traffic occurring through the connection interface 2 is that it takes place within the data storage device 1, via its own internal data buses 7, the data to be copied does not get transferred to the information technology device during copying through the connection interface 2, in other words, in this case there is no data traffic taking place through the connection interface 2, which enables significantly much faster copying.

Similarly, in the case of restoring the disc image the saved disc image copied to the dedicated, separate backup volume 5 of the data storage device 1 is written back to the primary volume 4 of the data storage device 1 only through the internal data buses 7 of the data storage device 1 (in other words without the use of the data buses of the information technology device) using the storage controller 3, and so without any data traffic occurring through the connection interface 2. Therefore, the data does not leave the data storage device 1 in this case either, which results in a significant increase in copying speed.

If the operation system stored on the primary volume 4 is also corrupted, then in order to recover the disc image first of all the information technology device (the host computer) is brought into operation with the auxiliary operation system stored on the service volume 6 of the data storage device 1. In the case the auxiliary operation system is put to use when the host computer is started the service volume 6 on the host computer is selected for booting (system loading), therefore when the host computer is booted the auxiliary operation system installed on the service volume 6 is loaded, in other words the host computer starts up with the auxiliary operation system running. Following this the recovery of the disc image takes place according to that described above. In the case of a preferred embodiment the auxiliary operation system has a remote administration option, in other words it is possible for a remote helper to perform the recovery.

The auxiliary operation system is used for operating the information technology device. In addition an internal operation system may also be provided in the data storage device 1 that serves for handling the files system created on the primary volume 4 and the backup volume 5, and for reading and writing the contents placed on them. The internal operation system is preferably installed on the primary volume 4, but it may also be installed on the backup volume 5 or on the service volume as well. The internal operation system in the case of a preferred embodiment is a Linux operation system, but, naturally, other operation systems may also be used. With its use the following extra services may be provided:
Internal file-level backup and recovery without the use of the host-side connection interface 2 (e.g. SATA)—The file-level data are selected and transmitted also with the use of the internal data bus 7 of the data storage device 1, with the help of the internal resources of the data storage device 1 similarly to the backup of the disc image presented previously. In other words the resources of the host computer are not used by the process.
Incremental file-level backup and recovery without the use of the resources of the host computer—In the case of the multiple backup of a given file only the data content of the storage blocks that have been changed are backed up in such a way that the resources required for the backup are provided by the data storage device 1, in other words the backup takes place without any data traffic occurring through the connection interface 2. Similarly, in this case recovery also takes place with the resources of the data storage device 1.
Incremental disc image backup and recovery without the use of the resources of the host computer—In the case of the multiple backup of the disc image only the data content of the storage blocks that have been changed are backed up in such a way that the resources required for the backup are provided by the data storage device 1, in other words the backup takes place without any data traffic occurring through the connection interface 2. Similarly, in this case recovery also takes place with the resources of the data storage device 1.

Therefore, in the case of the use of an internal operation system a file-level security backup of the digital data (data file) stored on the primary volume 4 is made so that during this process the data file to be backed up is accessed by the storage controller 3 of the data storage device 1 using the internal operation system, and the data file is copied through the internal data buses 7 of the data storage device 1 to the backup volume 5 of the data storage device 1 without and data traffic occurring through the connection interface 2.

Similarly, in the case of the file-level recovery of the backed up data file, the backed up data file copied onto the backup volume 5 of the data storage device 1 is written back onto the primary volume 4 of the data storage device 1 using the storage controller 3 with the help of the internal operation system through the data buses 7 of the data storage device 1, without any data traffic occurring through the connection interface 2.

In the case of the presented embodiment the physical structure of the individual volumes is provided as follows:

The primary volume 4 is storage space constructed from built-in flash memory, the backup volume 5 is storage space made from at least three micro SD cards, using known RAID technology, and the service volume 6 is logically separated storage space in the built-in flash memory or in one or more micro SD cards. The service volume 6 may also be formed by a dedicated flash memory or dedicated micro SD card. In the case of a further preferred embodiment the service volume 6 is located on at least two micro SD cards, in such a way that one copy of the auxiliary operation system is redundantly stored on each micro SD card, therefore even in the case one of the micro SD cards becomes faulty the host computer may be booted using the auxiliary operation system stored on the other micro SD card.

The purpose of the data storage device 1 is to realise secure data storage for the user of the host computer in such a way that the user is able to control it. Therefore, in addition to the hardware a preferable element of the solution is a user-side administration software program that continuously runs on the host computer, communicates with the data storage device 1 in the way determined in the standard of the connection interface 2, and that controls the operation of the data storage device 1. The administration software program preferably implements the following functions, preferably with the help of a graphic user interface:
Automatic disc image file and file-level backup setting, timing and control.
Managing file-level recovery.
Logging and viewing of processes.
Hardware firmware (built-in program) updating.
Hardware monitoring, error reporting, warnings.
Replication, copying of the data located on the backup volume 5 onto an external data store.

In other words, the administration software makes it possible for the user to determine and set the backup parameters (such as backup frequency, files to be backed up, etc.), meaning that the data is not simply duplicated or multiplied with the data storage device 1, instead security disc images or file-level backups can be created in an ad hoc or regular way that correspond to the demands of the user.

FIG. 8 depicts a detailed block diagram of a possible embodiment of the device according to the invention.

The figure presents a possible structure of an SSD-based solid-state data storage device 1. The figure illustrates the connection interface 2, the storage controller 3, the primary volume 4 and the backup volume 5, the service volume 6, and their main sub-units, as well as the logical connection existing between them, The physical implementation strongly depends on the technology selected.

The storage controller 3 contains the “A” memory group controller 11, the “B” memory group controller 13, the memory interfaces 15, multiplexers 16, a microcontroller interface 17, a microcontroller 18 and data buses 7.

Memories 12, 14

The primary volume 4 is comprised of the memories 12 belonging under the “A” memory group controller 11, these are typically realised with one or more eMMC circuits. The backup volume 5 serving for security backups contains memories 14 connected to the memory group controller “B” 13, these are typically micro SD cards. Although the figure shows a single eMMC and six micro SD cards, the number of these may be selected according to the demands. In the present case the service volume 6, and therefore the auxiliary operation system (such as a Linux operation system) may be found on the eMMC comprising the memory 12. Another possibility is that in addition to this or apart from this the service volume 6 is created on one or more micro SD cards comprising the memory 14.

Memory Interface 15

Each memory 12 is connected to the “A” memory group controller 11 via a memory interface 15 and a multiplexer 16, and each memory 14 is connected to the “B” memory group controller 13 via a memory interface 15 and a multiplexer 16 via the buses 7 marked “A” or “B”.

The memory interface 15 ensures a uniform constant data flow for the connected memory group controller 11 or 13 with the help of data flow control signals. The memory group controller 11 or 13 does not have to know the characteristics of the connected memories 12, 14. The uniform data flow is created by the memory interface 15 with the help of the program running in the microcontroller 18 with consideration to the characteristics of the physically connected memory 12, 14.

The memory interface 15 recognises and adjusts the following memory 12, 14 characteristics so that the data flow is as fast as possible:
Recognising and setting the data bus 7 bit width (1-bit, 4-bit, 8-bit),
Recognising and setting the method of data validation (data transfer takes place at the one edge (SDR) or at both edges (DDR) of the clock signal),
Recognition and setting of the maximum clock signal frequency (25 Hz, 50 MHz, 100 MHz, 200 MHz, 208 MHz),
Recognition and setting of the signal line voltage level (3.3V, 1.8V),
Setting other memory characteristics, operation modes, statuses,
Recognition and minimising of faults.

The memory interface 15 may be extended so that it is also able to handle other types of memory 12, 14, while the data flow control remains unchanged in the direction of the memory group controller 11, 13. With this method it may be achieved that only the memory interfaces 15 have to be replaced in the case of a new type of memory interface, the other parts do not require redesign or testing.

The memory interface 15 (FIG. 9) along with the connected memory 12 (eMMC circuit) or the memory 14 (SD card) forms a generalised memory that communicates with the outside world in the present example via the 32 bit write/read “A” or “B” data bus 7, and that has the necessary data flow control signal. The memory interface 15 is connected to the memory 14 or the memory 12 with a 4 or 8 bit data bus 7 and with the required control signals. The memory interface 15 is capable of handling both types of memory, i.e. eMMC or SD card. The advantage of this solution is that the required instantiation of the memory interface 15 may be achieved with minimal extra investment with a good price/performance value.

Two FIFO 151, 152 circuits may be found in the memory interface 15. While the one FIFO 151 is written or read by an external device connected to the memory interface 15, the content of the other FIFO 152 is written to the memory 12 or 14 connected to the memory interface, and written back here, in other words while the first FIFO 151 is being used by the external device connected to the memory interface 15, the second FIFO 152 is used for the memory 12 or 14, and when the second FIFO 152 is being used by the external device connected to the memory interface 15, the first FIFO 151 is used for the memory 12 or 14.

In the presented example a FIFO 151, 152 is 512 bytes, the input and output bus 7 width is 32 bits. The clock signal of writing to the input is independent of the clock signal of reading from the output and may even have different values. In the figure the FIFO 151, 152 circuits may be written and read in both directions, in order to promote understand of the operation. The FIFOs 151, 152 must be reversed with the multiplexers 154, 153 known in the physical implementation (which have both a multiplexer and demultiplexer function) depending on whether writing or reading is taking place. If the external device (either the memory group controller 11 or 13 in the present case) writes the memory interface 15, then the inputs of the FIFOs must be adjusted into the direction of the external device, and their outputs into the direction of the memories 12 or 14. As an alternative solution two FIFOs may be used for reading and two FIFOs for writing, in this case there is no need for the multiplexers 153, 154.

155 FSM

The FSM 155 (finite-state machine) ensures the operation of the memory interface 15.

The FSM 155 sends and received data flow control signals via the signal lines 8. Optionally, the signal lines 8 are only logical separated from the data buses 7, but for the sake of better understanding these have been depicted separately in FIG. 9. In addition the FSM 155 is also directly connected to the microcontroller 17 interface or to the microcontroller 18 shown in FIG. 8 via the SPI data bus 7.

SD/eMMC Memory Signals

CMD, CLK, DS, and RES signals, known to a person skilled in the art, are required for the basic operation realised with the FSM 155 of the memory interface 15 shown in FIG. 9. The RES (RESET) signal is used by the eMMC circuit of the memory 12, and the DS signal is only required on the occasion of high-speed data transfer. The type and services of the memory 12 or 14 are determined when the memory interface 15 is initialised. Accordingly, the microcontroller shown in FIG. 8 only activates the required SD/eMMC signals in a known way.

Data transfer may take place on the one (SDR) or both (DDR) edges of the clock signal. In the following the precise type of data transfer will not be detailed, simply only 4 or 8 bit writing or reading will be discussed. It will always be assumed that operation is performed at the greatest possible data transfer speed.

Data Flow Control Signals

Each FIFO 151, 152 has a signal line 8 facing the direction of an external unit (memory group controller 11 or 13) for sending and receiving the data flow control signals. These are designated as:
The data flow controller facing the direction of the external unit: ExtFull/ExtEmpty
The data flow controller facing the direction of the memories 12, 14: Full/Empty

The expression “full” conventionally means ‘full’, and the expression “empty” conventionally means ‘empty’. If an external unit writes the FIFO 151, 152 FIFO-t, this can only be performed if the value of the external data flow controller signal is: ExtFull/ExtEmpty=Empty, in other words the FIFO 151, 152 is empty. When the FIFO 151, 152 becomes full, in other words the 512 bytes have been written, the value of the data flow controller will be ExtFull/ExtEmpty=Full and simultaneously Full/Empty=Full, i.e. the data flow control signal facing the direction of the memories 12, 14 also signals in the direction of the memories 12, 14 that there is a full FIFO 151, 152.

If an external unit reads the FIFO 151, 152, this can only be done if the value of the external data flow controller signal is: ExtFull/ExtEmpty=Full, in other words the FIFO 151, 152 is full. When the reading of the 512 bytes has taken place then ExtFull/ExtEmpty=Empty and simultaneously with this Full/Empty=Empty, in other words the data flow controller signal facing the direction of the memories 12, 14 also indicate in the direction of the memories 12, 14 that the FIFO 151, 152 is free.

Although there are two FIFOs 151, 152, the external unit only sees one data flow controller signal, which is the data flow controller signal of that FIFO 151, 152, the data bus of which the external unit is using. This also means that the multiplexer 16 does not only select the data bus 7, but the data flow controller signal too.

SPI Handling

Using the FSM 155 registers can be written and read via the SPI (Serial Peripheral Interface) data bus 7. The writable registers set up various operation modes and store the parameters required for operation. The readable registers supply information on the status of the unit. A special register set performs the sending of the commands to the memories 12, 14 and receives the responses to them.

RESET

The FSM RESET (RES) signal forces all the components of the memory interface 15 into default state, irrespective of the statuses and processes currently existing. In this state the entire interface unit is inoperable, however, when it leaves this status it gets into a predefined, known state. RESET can be achieved in two ways, on the one part, with the help of a hardware signal not shown in the figure, and, on the other part, and through the SPI data bus 7.

Reading the Memories 12, 14

In the case of the present embodiment reading always takes place in blocks of 512 bytes. Reading may consist of just one block, or of a sequence of consecutive blocks. The method of multi-block reading, depending on the type and generation of the memories 12, 14, may be one of two forms: in the one case the number of blocks to be read can be given to the memories 12, 14, and in the other case a command must be sent to the memories 12, 14 as a result of which it stops sending any more blocks. Together the FSM and the microcontroller 18 must perform the following tasks in order to initialise the reading:
All the subunits of the memory interface 15 must be set into default status (FIFOs 151, 152, multiplexers 153, 154, bus width splitter 156).
Via the SPI the type of reading method, the address of the first block and, if necessary, the number of blocks to be read must be set in the memories 12, 14.
The block counter in the FSM must be set. This is where the number of blocks to be read goes. If the number of blocks to be read cannot be set in the memories 12, 14, then this counter will count the number of read blocks.
The reading must be started by continuously ensuring the clock signal of the memories 12, 14.

When the reading of a block is started the FSM monitors the D0 data signal and the start bit that appears here signals the start of the reading. When every memory 12, 14 is read, in the case of an SD card a 4-bit data, and in the case of an eMMC circuit and 8-bit data package is created. The bus width splitter forms a 32-bit data package from each of the sequential data packages. When a 32-bit data package has been created, it gets into the FIFO 151, 152. After 512 bits have been read the memories 12, 14 send a CRC (Cyclic Redundancy Check) signal per data line. The FSM also performs a CRC per data line. If the generated and received CRCs do not correspond, the data transfer was corrupted.

Two cases are possible after a block has been read.
No CRC error. The data flow controller signal of the FIFO used for the reading is activated (Full/Empty=Full), indicating with this that there is a valid 512 byte package in the FIFO 151, 152. The FSM block counter is reduced by one indicating with this that one less block still needs to be read. After this a further two cases are possible:
   The data flow controller signal of the of the other FIFO 151, 152 indicates that the FIFO 151, 152 is empty (Full/Empty=Empty), so the reading may be continued into this FIFO 151, 152. The multiplexer 153 is set to this FIFO 151, 152 and the reading is continued by maintaining the clock signal of the memories 12, 14, waiting for the start bit of the following block.
   The data flow controller signal of the of the other FIFO 151, 152 indicates that the FIFO 151 is not empty (Full/Empty=Full). This means that the device connected to the memory interface 15 has not yet succeeded in reading this FIFO 151, so it must be waited for. The clock signal of the memories 12, 14 is suspended until the FIFO 151 is read, i.e. until the data flow controller signal changes to Full/Empty=Empty status. After this the reading of the next block can be continued.
There is a CRC Error. The FSM 155 block counter is not reduced, because there was an error during reading. The CRC error does not indicate an error in the memory of the given block, only that there was an error during data transfer, consequentially a repeated block reading will be (may be) successful. The FSM 155 signals the fact of the CRC error to the microcontroller 18 in a status bit. The microcontroller 18 reads the block counter of the FSM 155, then initialises the interface to read a completely new block, but it gives the address of the badly read block as starting block address, and also reduces the number of blocks to be read subtracting the number of blocks successfully read to this point from the original value. For this it uses the value of the block counter read from the FSM 155.

When the block counter of the FSM 155 changes to zero after a successfully read block, the reading is ended. If the number of blocks to be read could not be given to the memories 12, 14 when reading was initialised, because it did not have this characteristic, the block counter of the FSM 155 changing to zero sends a command to stop block reading to the memories 12, 14 on the memory command (CMD) line. The sending of this command does not require activation of the microcontroller 18, it takes place automatically.

Memory Writing

In the present case writing always takes place in blocks of 512 bytes. Writing may consist of just one block, or of a sequence of consecutive blocks. The method of multi-block writing, depending on the type and generation of the memories 12, 14, may be one of two forms: in the one case the number of blocks to be written can be given to the memories 12, 14, and in the other case a command must be sent to the memories 12, 14 which indicates the end of the writing. Together the FSM and the microcontroller 18 must perform the following tasks in order to initialise the writing:
All the subunits of the memory interface 15 must be set into default status (FIFOs 151, 152, multiplexers 153, 154, bus width splitter 156).
Via the SPI the type of writing method, the address of the first block and, if necessary, the number of blocks to be written must be set in the memories 12, 14.
The block counter in the FSM must be set. This is where the number of blocks to be written goes. If the number of blocks to be written cannot be set in the memories 12, 14, then this counter will count the number of blocks.
The writing must be started by continuously ensuring the clock signal of the memories 12, 14.

The block to be written may be found in that FIFO 151, 152 which the multiplexer 153 is set to. It is conceivable that the FIFO 151, 152 has not yet become filled, therefore the writing of the memories 12, 14 cannot be started. By interrupting the clock signal of the memories 12, 14, the filling of the FIFO 151, 152 must be waited for, in other words until the data flow controller signal gets into Full/Empty=Full status. Then the clock signal is activated and the writing starts. The bus width splitter splits up the 32 bit data read from the FIFO 151, 152 into 4-bit data packages in the case of an SD card and into 8-bit packages in the case of an eMMC, then the 4/8 bit data packages get into the memories 12, 14 one after the other. The FSM 155 generates a CRC per data line, then after 512 bytes have been written this is also sent to the memories 12, 14. A short response arrives to this, on the basis of which the following two cases are possible:
The memories 12, 14 signal that there was no CRC error, the data were written faultlessly. The FSM reduces the block counter, as a block was written without error. Following this a further two cases are possible:
   The memories 12, 14 signal that they are not busy, and that the next block can be sent. The FSM switches the multiplexer to the other FIFO 151, 152. If this FIFO 151, 152 is full (Full/Empty=Full), the writing of the next block can start, otherwise the clock signal of the memories 12, 14 is suspended until the data flow controller signal changes to Full/Empty=Full status.
   The memories 12, 14 signal that they are busy. The termination of this status must be waited for then the process continues according to the previous point.
The memories 12, 14 signal that there was a CRC error, i.e. data transfer was corrupted. The block counter of the FSM 155 is not reduced, because there was an error in writing. The CRC error does not signal an error in the given block, only that there was an error in data transfer, consequentially a repeated block reading will be (may be) successful. The FSM 155 signals the fact of the CRC error to the microcontroller 18 in a status bit. The microcontroller 18 reads the block counter of the FSM 155, then initialises the memory interface 15 to write a completely new block, but it gives the address of the badly written block as starting block address, and also reduces the number of blocks to be written subtracting the number of blocks successfully written to this point from the original value. For this it uses the value of the block counter read from the FSM 155

When the block counter of the FSM 155 changes to zero after a successfully written block, the writing is ended. If the number of blocks to be written could not be given to the memories 12, 14 when writing was initialised, because it did not have this characteristic, the block counter of the FSM 155 changing to zero sends a command to stop writing a given block to the memories 12, 14. The sending of this command does not require activation of the microcontroller 18, it takes place automatically.

Energy Management

At those times when the memory interface 15 and the memories 12, 14 are not in use, it is preferable to reduce consumption. The extent of the reduction may be implemented in several steps. The lower the energy consumption, the longer the reaction time to leave reduced consumption mode. The FSM 155 together with the microcontroller 18 can switch the memories 12, 14 to and from reduced energy mode using commands. The FSM 155 can be set to reduced energy mode via the SPI data bus 7. In this mode the FSM 155 stops the unused clock signals, and maintains the subunits in default status.

The “A” and “B” Memory Group Controllers 11, 13

The structure of the “A” and “B” memory group controllers 11, 13 is identical (see FIG. 10), they contain the FSM 155, multiplexers 112, 113 (which perform both multiplexer demultiplexer functions), also signal lines 8, SPI data bus 7 and a further 32-bit data bus have also been indicated for the following reasons. The “A” memory group controller 11 is connected to the “A” data bus 7, and the “B” memory group controller 13 is connected to the “B” data bus 7. Multiplexers 16 (which are both multiplexers and demultiplexers) selecting between the “A” and “B” data buses 7 are connected to the memory group controller 11, 13, and eMMC or SD elements, i.e. memories 12 or 14, can also be connected with the use of memory interfaces 15. The memories 12 or 14 connected in this way appear as a single large primary or backup memory from the point of view of the SSD data bus 7 connecting the input of the “A” and “B” memory group controllers 11, 13 with the connecting interface 2, with a 32-bit data bus 7 and data flow control signals.

FSM 115

The FSM 115 (finite-state machine) ensures the operation of the memory group controller 11, 13. It performs the following main tasks.

SPI Handling

Registers can be written and read through the SPI data bus 7. The writeable registers set up various operation modes and store the parameters required for operation. The readable registers provide information on the status of the unit.

RESET

The FSM 115 RESET signal forces all the components of the memory group controller 11, 13 into default status, irrespective of the currently existing statuses and processes. In this status the memory group controller 11, 13 is inoperable, however, on getting out of this status it gets into a predefined, known status. RESET may be achieved in one of two ways, on the one part, it may be set with the use of a hardware signal, and, on the other part, via SPI communication.

Memory Reading

In the course of reading, those memories 12, 14 are read that belong under the memory group controller 11, 13. Together the FSM 115 and the microcontroller 18 must perform the following tasks to initialise the data reading:
The subunit must be set to default status.
The serial number of the first and last memory interface 15 must be given via SPI communication, which is handled by the given group controller 11, 13. For example, if only one eMMC-interfaced memory interface 15 belongs under the “A” memory group controller 11 and this is the first, then the serial number of the first and the last memory interface 15 is also 1. If the memory interface 15 connecting the 2 to 6 SDs belong under the “B” memory group controller 13, then the serial number of the first interface is 2 and the serial number of the last interface is 6.
The serial number of that memory interface 15 in which the first block to be read is located is given via SPI communication.
The number of all the blocks to be read is given via SPI communication. This corresponds with the total of the value of the block counters belonging under the memory group controller 11, 13.

The reading is started with the reading of the memory interface 15 in which the first block to be read is located. Once this is read, the next one is started and the reading is continued. Once the last memory interface 15 that still belongs under the memory group controller 11, 13 has been read, then it is the turn of the first memory interface 15 that belongs under the memory group controller 11, 13, then the reading is continued. The value of the block counter changes by one on the occasion of every change. The reading comes to an end when the block counter changes to zero.

When it is the turn of the next interface the memory group controller 11, 13 sets the multiplexer 112 and the multiplexer 113 (which at this time also functions as a demultiplexer) onto the next memory interface 15. If here the ExtFull/ExtEmpty signal of the given interface is in Empty status, then there is no readable data yet. This signal gets to the bus controller (HOLD REQ), which suspends the reading (TRNEN) until the FIFO 151 gets full.

Before reading the microcontroller 18 initialises the memory interfaces 15 and the memory group controller 11, 13 for reading, then starts the reading. All the memory interfaces 15 start reading immediately. However, the first block must be waited for, therefore, in the case of reading there is sure to be at least one (the first) read where the group controller requests data flow suspension. If the eMMC or SD cards comprising the memories 12, 14 are able to read at the same speed, by the time the reading of the second block starts, the FIFO 151, 152 of the next memory interface 15 will be full, and so no suspension is requested.

Memory writing

In the case of writing those memories 12, 14 are written that belong under the memory group controller 11, 13. Together the FSM 115 and the microcontroller 18 must perform the following tasks to initialise the data writing:
The subunit must be set to default status.
The serial number of the first and last memory interface 15 must be given via SPI communication, which is handled by the given group controller 11, 13. For example, if only one eMMC-interfaced memory interface 15 belongs under the “A” memory group controller 11 and this is the first, then the serial number of the first and the last memory interface 15 is also 1. If the memory interface 15 connecting the 2 to 6 SDs belong under the “B” memory group controller 13, then the serial number of the first interface is 2 and the serial number of the last interface is 6.
The serial number of that memory interface 15 in which the first block to be written is located is given via SPI communication.
The number of all the blocks to be written is given via SPI communication. This corresponds with the total of the value of the block counters in the memory interfaces 15 belonging under the memory group controller 11, 13.

The writing is started with the writing of the memory interface 15 in which the first block to be written is located. Once this is written, the next one is started and the writing is continued. Once the last memory interface 15 has been read, then it is the turn of the first memory interface 15 that belongs under the memory group controller 11, 13, then the writing is continued. The value of the block counter drops by one on the occasion of every change. The writing comes to an end when the block counter changes to zero.

When it is the turn of the next memory interface 15 the memory group controller 11, 13 sets the multiplexer 112 and the multiplexer 113 (which at this time also functions as a demultiplexer) onto the next memory interface 15. If here the ExtFull/ExtEmpty signal of the given interface is in Full status, then the FIFO 151 cannot be written, because it is full. This signal gets to the bus controller (HOLD REQ), which suspends the writing (TRNEN) until the FIFO 151 gets empty.

Energy Management

At those times when the memory group controller 11, 13 is out of use, the energy consumption must be reduced. The FSM 155 can be set to reduced energy mode via the SPI data bus 7. In this mode the FSM 155 stops the unused clock signals, and maintains the subunits in default status.

RAID

In the solution outlined above the memory group controller 11, 13 only links the memories 12, 14 under it in RAID0 mode, but redundant data storage does not take place, so there is no increased data protection. From the aspect of system-technology the memory group controller 11, 13 can be changed so that it uses the one memory unit for parity storage in RAID4 mode, or establishes circulating parity storage, RAID5. Increased data protection is not absolutely necessary in the case of more developed memories, as these already contain fault correction.

Microcontroller Interface 17

With the help of the microcontroller interface 17 shown in FIG. 11 the microcontroller is able to write and read the memories 12, 14 existing on the SSD data bus 7, and the FIFO circuits. These are:
the FIFOs of the memory 12 group belonging under the “A” memory group controller 11
the FIFOs of the memory 13 group belonging under the “B” memory group controller 13
the FIFOs of the connecting interface 2 (SATA/PCIe/USB connection)

The data transfer speed is not time-critical, there is no need for the movement of a large amount of data.

A further task of the microcontroller interface 17 is to handle the two data flow control signals (HOLD REQ TRNEN) on the SSD data bus 7, which it carries out with the help of the data bus controller 173 (see FIG. 11).

The microcontroller interface 17 contains a writeable and a readable 32-bit register 171 and 172. The microcontroller 18 is able to write and read these registers 171, 172 through the SPI data bus 7. After a given write or read has been performed the registers 171, 172 are connected to the SSD data bus 7 and can be read and written from the direction of the SSD data bus 7.

Data Flow Control

An internal data flow suspension request signal is located in the interface, which works in the same way as the HOLD REQ signal arriving from the SSD bus. Due to the effect of the suspension request the TRNEN data transfer authorisation signal becomes inactive, and the data traffic on the SSD bus is suspended as long as the suspension request is active.

Bus Controller

Any unit on the SSD bus can request suspension of the data flow by activating the HOL REQ signal. The bus controller detects the request and makes the TRNEN signal inactive. This signal stops the data transfer between the two units participating in the data transfer.

FSM 175

The FSM 175 (finite-state machine) ensures the operation of the microcontroller interface 17. It performs the following main tasks.

SPI Handling

Registers 171, 172 can be written and read through the SPI data bus 7 using the microcontroller 18. The writeable registers set up various operation modes and store the parameters required for operation. The readable registers provide information on the status of the unit.

RESET

The FSM 175 RESET signal forces the microcontroller interface 17 into default status, irrespective of the currently existing statuses and processes. In this status the microcontroller interface 17 is inoperable, however, on getting out of this status it gets into a predefined, known status. RESET may be achieved in one of two ways, on the one part, it may be set with the use of a hardware signal, and, on the other part, via communication through the SPI data bus 7.

Reading

The microcontroller 18 is able to read the unit on one of the SSD data buses 7 by initialising the given unit for reading, and by initialising the microcontroller interface 17 for writing. Following this it authorises data traffic (TRNEN active). When the writing of the 32-bit register 172 in the microcontroller interface 17 has taken place, the FSM 175 requests suspension via the internal HOLD REQ signal. The data traffic on the SSD data bus 7 stops, and the register 172 of the microcontroller interface 17 can be read via the SPI data bus 7. After the reading has taken place the internal HOLD REQ signal becomes inactive, enabling reading of the following 32-bit data package.

Writing

The microcontroller 18 is able to write the unit on one of the SSD buses by initialising the given unit for writing, and by initialising the microcontroller interface 17 for reading. Following this it authorises data traffic (TRNEN active). When the reading of the 32-bit register 171 in the microcontroller interface 17 has taken place, the FSM 175 requests suspension via the internal HOLD REQ signal. The data traffic on the SSD data bus 7 stops, and the register 171 of the microcontroller interface 17 can be read via the SPI data bus 7. After the new data has been written the internal HOLD REQ signal becomes inactive, enabling writing of the following 32-bit data package.

Energy Management

At those times when the microcontroller interface 17 is out of use, the energy consumption must be reduced. The FSM 175 can be set to reduced energy mode via the SPI data bus 7. In this mode the FSM 175 stops the unused clock signals, and maintains the subunits in default status.

FIG. 8a illustrates an embodiment that contains a built in operation system environment 200 that runs its own internal operation system. The built-in operation system environment 200 is illustrated in more detail in FIG. 8b: in the case of this embodiment it contains a microprocessor 202, flash memory 204 and DRAM 206 (dynamic random access memory—dynamic RAM), which together, in a way known in itself, provide the built-in operation system environment 200. In the case of this embodiment the microprocessor 202, similarly to the microcontroller interface 17, also communicates with the other units via the 32-bit data bus 7, the SPI data bus 7 and the signal line 8. In other respects the embodiment according to FIG. 8a does not differ from the embodiment according to FIG. 8, therefore that described in connection with it correspondingly relate to this embodiment also, with difference that the functions of the microcontroller interface 17 and the microcontroller 18 are performed by the built-in operation system environment 200.

The solid-state data storage device 1 can be operated in two operation modes with the method according to the invention. In the first case, in the case of normal operation it may be used as operational SSD background storage, and in the other operation mode it is used for security backup and recovery.

The solid-state data storage device 1 is connected to the host computer via a known communication medium, such as SATA, PCIe, USB, and the memory interface 15 facilitates this.

Data Storage Operation Mode

In data storage operation mode the main data transfer takes place between the connection interface 2 and the “A” memory group controller 11. Memories 12 can be connected to this memory group controller 11. It is preferable to use eMMC memory as the primary volume, as the handling of the memory is more refined as compared to SD cards. In general it is sufficient to use one memory 12, but two or even more memories 12 can be connected to the “A” memory group controller 11 in the interest of achieving greater capacity or higher data transfer speed.

Recovery Operation Mode

Two cases are differentiated in this operation mode. In the first case the data on the memories 12 belonging under the “A” memory group controller 11 are copied to the memories 14 belonging under the “B” memory group controller 13 and with this a bit-precise copy (disc image backup) is created of the data storage device seen by the host computer.

In the second case the direction of the data is reversed, the content of the memories 14 belonging under the “B” memory group controller 13 are copied back to the memories 12 of the “A” memory group controller 11, in other words the content of the data storage device seen by the host computer is recovered. The memory group controllers 11, 13 take part in the data exchange, and the data exchange takes place through the SSD data bus 7. The connection of the memories 12, 14 connected under the memory group controllers 11, 13 is configuration-dependent.

There are several methods available for issuing the recovery command. The physical implementation may vary according to demand. Some possible solutions:
By using an auxiliary program. This may only be used if the operation system of the host computer has not crashed.
Hidden button on the device. Its disadvantage is that it is difficult to access.
If the device 1 contains a USB port, it is possible to communicate with the microcontroller 18 through this. Its disadvantage is that it is difficult to access the USB port.
If the device 1 contains a WIFI module, this is used to connect to the microcontroller 18. Its disadvantage is that it makes the device 1 more expensive.

As it was mentioned previously, a special solution can also be produced as a result of the structure of the data storage device 1. The space on the memory 14 belonging under the “B” memory group controller 13 is divided into two parts. A freely useable operation system, such as Linux, is installed on a smaller part, and the other area is used for security backup. If the host computer is started from the “B” memory group controller 13 instead of the “A” memory group controller 11, then a recovery can be initiated under the undamaged auxiliary operation system (e.g. Linux).

A preferred embodiment of the data storage device 1 according to the invention is outlined in FIG. 12 in which the solid-state memories 14 forming the backup volume 5, notably micro SD cards, may be inserted in the slots 23 provided in the housing 22 of the device 1, and if necessary ensure easy access for the user, therefore in the case of a serious fault in the one or more solid-state memories forming the primary volume 4 the micro SD cards 19 forming the backup volume 5 can be simply transferred into the corresponding slots 23 of another solid-state data storage device 1 with the same structure, and the entire data content of the backup volume 5 can be copied using disc image recovery into the one or more solid-state memories (such as eMMC memories 12) forming the primary volume 4 of the second solid-state data storage device 1.

In the case of an ultrathin computer (e.g. Ultrabook) the solution can be provided so that the storage controller 3 is integrated into the host motherboard, and the primary volume 4 is connected to the motherboard of the host via a standard connection interface (e.g. PCI), and the storage elements comprising the backup volume 5 are located on the external housing of the host in such a way that they are accessible without taking the host apart, for example, in the case of a backup volume 5 constructed from micro SD cards 19, they can be accessed via the SD card slots formed in the housing of the host. In this embodiment the storage controller 3 communicates with the primary volume 4 through the aforementioned standard connection interface, e.g. PCI, while the data of the backup volume 5 are accessed with the help of the SSD bus 7.

When in use the solid-state data storage device 1 according to the invention is connected to a host computer, which in most cases means it is built in.

After the solid-state data storage device 1 has been installed in the computer it behaves as a traditional drive: the operation system, and other software can be installed onto it in the conventional way, then after the environment has been finalised or even before that the software application serving for handling the solid-state data storage device 1 can be installed onto it, which is preferably coupled to system administration entitlement.

The listed software and the user software on the computer as well as the data related to the software are all located on the primary volume 4.

As it has already been mentioned, the backups provided by the solid-state data storage device 1 are saved onto the backup volume 5. The memory 14 providing the backup volume 5 consists of several separate micro SD cards 19 in the presented embodiment. This arrangement ensures that in the case of a hardware fault in the solid-state data storage device 1 the entire system can be recovered by putting the micro SD cards 19 into a replacement solid-state data storage device 1.

Disc Image Backup

Following installation and making the user settings, by using the aforementioned application a disc image backup can be made in the way presented in connection with FIG. 5, which in a known way contains the operation system, all the installed software, all settings, and all the stored documents. The backup takes place via the internal data bus 7 within the solid-state data storage device 1, therefore the backup speed may significantly exceed the data transfer speed achievable with the standard used by the interface of the host computer and the connection interface 2 connected to it. For example, in the case of an interface 2 according to the SATA standard the maximum data transfer speed may be 600 Mbyte/sec, as compared to this the copying speed achieved during copying through the internal data buses 7 is significantly greater than this, e.g 1200 Mbyte/sec or even 1500 Mbyte/sec.

File Backup

Automatic backups can be made of documents and files created in a running, operating system to the backup volume 5 according to that described in connection with FIG. 3. This can be performed as a timed process running in the background. During backup the internal storage controller 3 of the solid-state data storage device 1 copies the data from the primary volume 4 to the backup volume 5 at a high speed, at a speed as much as 1000 Mbit/sec depending on structure in the case of a SATA device.

Disc Image Recovery

In order to recover a disc image stored on the backup volume 5 the host computer is preferably booted from the service volume 6, which service volume 6 may contain, for example, a built-in Linux operation system. The recovery of the selected disc image may be initiated on the interface appearing. During this process the storage controller 3 of the solid-state data storage device 1 copies the data from the backup volume 5 consisting of micro SD cards 19 to the primary volume 4 through the internal data buses 7 in the way presented in FIG. 6, in other words at a significantly greater speed than the connection interface 2 would otherwise make possible. At the end of the process the previously backed up environment becomes accessible by rebooting the computer.

File Recovery

In the case of a system running on the primary volume 4 of the solid-state data storage device 1, it is possible to individually recover the backed up files by using the aforementioned application. During this process the selected folders or files of the selected backup are copied back from the backup volume 5 to the folder selected by the user on the primary volume 4 according to that described in connection with FIG. 4. The aforementioned application preferably runs continuously and communicates with the solid-state data storage device 1 in the background.

Various modification to the above disclosed embodiments will be apparent to a person skilled in the art without departing from the scope of protection determined by the attached claims.

1. Method for the backing up and recovery of digital data stored on a solid-state data storage device (1), including
operatively connecting the solid-state data storage device (1) to an information technology device via a connection interface (2),
writing the data created during the operation of the information technology device onto the data storage device (1) via the connection interface (2) with the use of a storage controller (3) of the data storage device (1),
transmitting the data previously stored on the data storage device (1) that becomes necessary during the operation of the information technology device to the information technology device via the connection interface (2) with the use of the storage controller (3) of the data storage device (1);
characterised by that during the method creating a disc image level security backup of the digital data stored in a primary volume (4) of the data storage area of the data storage device (1) during which by using the storage controller (3) of the data storage device (1) copying the data through internal data buses (7) of the data storage device (1), without data traffic through the connection interface (2), from the primary volume (4) to a physically separate backup volume (5) of the data storage area of the data storage device (1), and copying the disc image level security backup created on the dedicated separate backup volume (5) through the internal data buses (7) of the data storage device (1), without data traffic through the connection interface (2), back to the primary volume (4) of the data storage device (1) using the storage controller (3) in the case of disc image recovery.

2. Method according to claim 1, characterised by providing a service volume (6) on the data storage area of the data storage device (1), preferably as a part of the backup volume (5), onto which an auxiliary operation system is installed for ensuring the operation of the information technology device, and in order to recover the disc image, booting the information technology device using the auxiliary operation system stored on the service volume (6) of the data storage device (1) when starting up the information technology device.

3. Method according to claim 1, characterised by providing the data storage device (1) with an internal operation system suitable for handling the files stored on the primary volume (4), and creating a file level security backup of the digital data stored on the primary volume (4) in the course of which, by using the storage controller (3) of the data storage device (1) and with the help of the internal operation system of the data storage device (1), accessing the data to be backed up and copying the data to the backup volume (5) of the data storage device (1) via the internal data buses (7) of the data storage device (1), without data traffic through the connection interface (2), and in the case of the file level recovery of the backed up data, writing the file level security backup copied onto the backup volume (5) of the data storage device (1) by using the storage controller (3) and with the help of the internal operation system of the data storage device (1) back onto the primary volume (4) of the data storage device (1) through the internal data buses (7) of the data storage device (1), without data traffic through the connection interface (2).

4. High-security solid-state data storage device, which contains:
a connection interface (2) connectable to a data storage interface of an information technology device,
a storage controller (3) connected to the connection interface (2),
a primary solid-state data storage forming a primary volume (4), which is in a bidirectional data communication connection with the storage controller (3), and which has a primary operation system installed on it for ensuring the operation of the information technology device characterized by that the data storage device (1) contains further solid state data storage which further solid state data storage is made up of storage modules that are accessible to and removable and replaceable by the user, which are in a bidirectional data communication connection with the storage controller (3), furthermore the storage controller (3) is provided as a control unit containing computer program commands for causing the solid state data storage device (1) to execute the method according to claim 1.

5. Data storage device according to claim 4, characterized by that the data storage capacity of the further solid state data storage is 1.5 to 2 times the data storage capacity of the primary solid state data storage of the data storage device (1).

6. Data storage device according to claim 4, characterized by that the storage modules are provided in the form of micro SD cards.

7. Data storage device according to claim 4, characterized by that the storage controller (3) connected to the storage modules is a control unit for ensuring at least one type of standard RAID control with respect to the storage modules.

8. Data storage device according to claim 4, characterized by that the service volume (6) is established within the further solid state data storage logically separated from the backup volume (5).

9. Data storage device according to claim 4, characterized by that the further solid state data storage and the storage controller (3) are arranged inside a standard sized housing of the data storage device (1) containing the primary solid state data storage.

10. Data storage device according to claim 9, characterized by that the storage modules of the further solid state data storage are provide in the form of micro SD cards (19) that are arranged in SD card slots (23) provided in the standard sized housing of the data storage device (1).

11. Data storage device according to claim 4, characterized by that it has a service volume (6) that is in a bidirectional data communication connection with the storage controller (3) and contains an auxiliary operation system for ensuring the operation of the information technology device.

12. Data storage device according to claim 4, characterized by that it contains user-side administration software serving for setting up the operation of the data storage device (1) by the user and for running on the information technology device. cm 13. Data storage device according to claim 4, characterized by that the storage controller (3) is integrated in a motherboard of the information technology device, and the primary volume (4) is connected to the motherboard through a standard connection interface, and the storage modules forming the backup volume (5) are located in slots in the external housing of the information technology device.
